(19) United States
(12) Patent Application Publication
(10) Pub. No.: US 2012/0261979 A1
(43) Pub. Date: Oct. 18, 2012

(54) Highly efficient fixed gap bicycle axel skewer and method of use

(76) Inventor: J. Leonard Ashman, Folsom, CA (US)

(21) Appl. No.: 13/066,297

(22) Filed: Apr. 12, 2011

(51) Int. Cl. B60B 35/04

(52) U.S. Cl. 301/124.2

(57) ABSTRACT

The present invention teaches an apparatus and method of use for a highly efficient bicycle skewer. In each of three separate embodiments an insert moves laterally with respect to a captive nut in such a way as to provide the necessary clearance required to remove a wheel or attach a wheel to a bicycle frame. The apparatus is constructed in such a way as to allow the removal and attachment without the need for adjustment of the skewer as is required by the prior art devices and is suitable for both front and rear wheels.

### BRIEF DESCRIPTION

The subject of this invention relates to the bicycle industry. More specifically, the disclosed invention teaches a novel bicycle axel skewer that once set, maintains the proper gap between the skewer and mounting lugs of a bicycle frame thereby improving the user's ability to maintain the bicycle. The apparatus of the disclosed invention may be used for driven and non-driven hubs.

### BACKGROUND OF THE INVENTION

Chain driven bicycle drive trains have existed for many years. Generally the chain receives power input from a peddle crank that has a motive force exerted upon it from a rider's legs. The force is transferred by the chain to the driven wheel by a geared cog, for example, which is in turn mechanically linked to a hub. The hub is attached to the drive wheel by means of spokes or solid inserts such as in the so-called disk wheels. In this way linear force from a rider's legs is transformed to rotational force applied to the wheel and then to the road surface.

From time to time the wheels of a bicycle must be detached from the bicycle frame, for example, to change a flat tire or to replace a worn part. There exist many contemporary methods for attaching the a wheel to the bicycle frame. One method uses a solid axle threaded on both ends. Once the axle ends have been located correctly in the frame lugs, nuts are tightened to fix the wheel in place. A second method uses a hollow axle through which a rod, referred to in the art as a skewer, is run. One end of the skewer has a lever and the other end an adjustable nut. Once the wheel is in the correct position in the lugs of the bicycle frame the lever is operated which results in a clamping force to fix the wheel in place.

While these methods are functional, they suffer from a common flaw. In both cases the rider must perform multiple steps to remove the wheel for the bicycle frame. In the first case, a wrench must be used to loosen both nuts, then the nuts run out away from the frame lugs prior to removing the wheel. In the case of the lever operated skewer, once the tension on the skewer rod has been released by operating the lever, the nut on the opposite side from the lever must be loosened in order to clear the frame lugs to allow removal of the wheel.

Once the wheel is clear, maintenance can occur. But the same problems exist upon remounting of the wheel. For the case of the solid axel, the wheel must be inserted into the frame lugs, then each of the nuts run in to fix the wheel in place, then a wrench must be applied to both nuts to firmly secure the wheel in place. For the case of the lever operated skewer, the wheel must be located in the frame lugs, then the nut run in to the approximate position required to engage the lever, then the rider must operate the lever to see if the nut is in the correct position. This process must be repeated several times in order to ensure proper capture of the dhub in the bicycle frame. Both of these method require numerous steps and are very inefficient.

What would be desirable is a method for mounting/dismounting a bicycle wheel that eliminated the need for the user to deal with nuts or inefficient lever mechanisms. The apparatus of the present invention provides an improved wheel mounting/dismounting method that accomplishes this as well as eliminating other problems related to the prior art methods discussed above.

### SUMMARY OF THE INVENTION

The present invention teaches an apparatus and method of use for a highly efficient bicycle skewer. In each of three separate embodiments an insert moves laterally with respect to a captive nut in such a way as to provide the necessary clearance required to remove a wheel or attach a wheel to a bicycle frame. The apparatus is constructed in such a way as to allow the removal and attachment without the need for adjustment of the skewer as is required by the prior art devices and is suitable for both front and rear wheels.

Each of the three embodiments of the present invention also has the advantage of keeping all wheel mounting hardware, such as the alignment springs and captive nut, together so that when the wheel is removed no pieces are lost. All embodiments of the present invention are self limiting so that a rider knows positively that the proper lug clearance had been reached. Since the present invention requires only an initial adjustment, once the wheel is ready to be remounted, no trial-and-error need be accomplished to guarantee a precise fit and clamp force on the lugs of the bicycle.

The three embodiments of the present invention work on the same principle and differ only in the implementation of that principle. Each of the embodiments uses a concentric insert that travels along a thread internal to a captive nut. The initial adjustment involves setting the proper lug clearance, then fixing the relative position of the insert with respect to the captive nut. Once accomplished, the lateral movement needed to provide the proper lug clearance gap is done through operation of a lever and cam mechanism common in the art.

The first embodiment of the present invention uses a simple shear force differential. The shear force between the external threads of the insert and the internal threads of the captive nut is greater than the shear force between the threads of the skewer rod and the internal threads of the insert. Thus when the skewer rod is rotated the skewer rod/insert combination moves laterally with respect to the captive nut creating a gap sufficient for wheel removal and/or remounting.

The second embodiment of the present invention uses a set screw method. The shear force between the external threads of the insert and the internal threads of the captive nut are generally the same as the shear force between the threads of the skewer rod and the internal threads of the insert, however, a set screw is used to fix the skewer rod/insert combination once the proper gap has been determined. Thus when the skewer rod is rotated the skewer rod/insert combination moves laterally with respect to the captive nut creating a gap sufficient for wheel removal and/or remounting.

The third embodiment of the present invention again uses a simple shear force differential. The shear force between the external threads of the insert and the internal threads of the captive nut is greater than the shear force between the threads of the skewer rod and the internal threads of the insert in the same way as in the first embodiment, however in the third embodiment the shear force differential is accomplished through the use of a jam nut on the internal threads of the insert. Thus when the skewer rod is rotated the skewer rod/insert combination moves laterally with respect to the captive nut creating a gap sufficient for wheel removal and/or remounting. As discussed below in conjunction with drawings provided, all three embodiments of the present invention provide a superior solution for riders.

### BRIEF DESCRIPTION OF THE DRAWINGS

FIG. 1: is an exploded/sectioned view of the apparatus of the present invention.

FIG. 2: provides details of the apparatus and operation of a first embodiment of the present invention.

FIG. 3: provides details of the apparatus and operation of a second embodiment of the present invention.

FIG. 4: provides details of the apparatus and operation of a third preferred embodiment of the present invention.

FIG. 5: provides the details of the installation and method of use of the present invention.

### DETAILED DESCRIPTION OF PREFERRED EMBODIMENTS

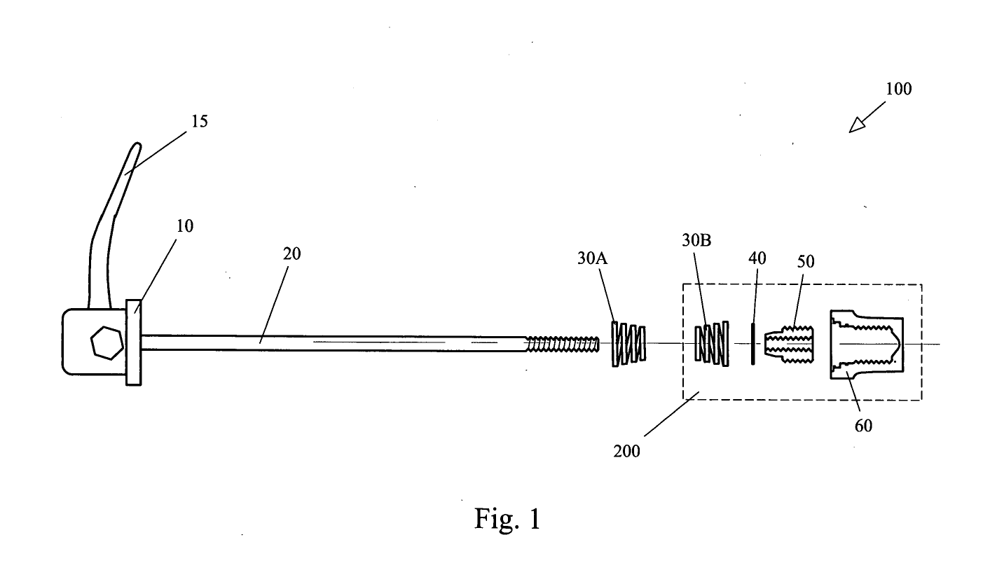

As described briefly above, the apparatus and method of the present invention provides a highly efficient bicycle wheel mounting skewer. FIG. 1 shows an exploded view of the apparatus of the present invention 100. A cam housing 10 contains an internal cam (not shown) which is operated by lever 15. The cam is attached to skewer rod 20 such that when lever 15 is operated the cam causes the skewer rod 20 to move approximately 0.2 inch laterally. Note that since the lever 15, housing 10 and cam are of the conventional type and well understood in the art, no detailed drawing or description is provided for clarity.

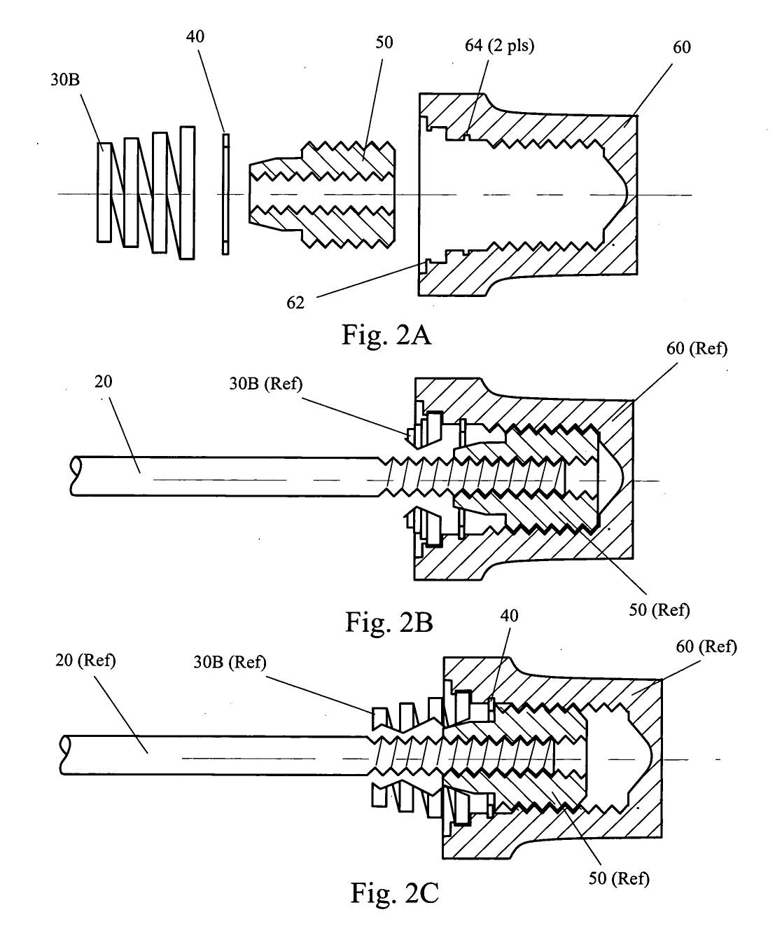

Spring 30A and spring 30B are of the conventional type, but both utilize a unique shouldered capturing means such that when the bicycle wheel is removed from the bicycle frame the springs 30A and 30B remain in place. This is an advantage over conventional methods since in these methods the springs are free to move along the skewer rod 20 making it difficult to insert the wheel into the lugs when remounting. Moreover, in conventional methods if the nut is inadvertently removed from the solid axel or the skewer rod the springs are easily lost. In the present invention for both springs, as discussed below in conjunction with FIGS. 2, 3 and 4, a lip is provided to capture the spring.

Looking now at captive nut assembly 200 comprised of captive nut 60, insert 50, stop ring 40 and spring 30B, the novelty of the present invention is shown in detail. As discussed below, these three parts combine to provide an elegant and efficient method for setting a precise fixed gap between the frame lugs of a bicycle and the skewer such that each time the lever 15 is operated, the cam housing 10 and the captive nut 60 separate by the exact distance needed to remove the wheel from the frame. Upon remounting, since the gap is fixed and therefore remains unchanged, the wheel will slip into place without the need to adjust the skewer mechanism.

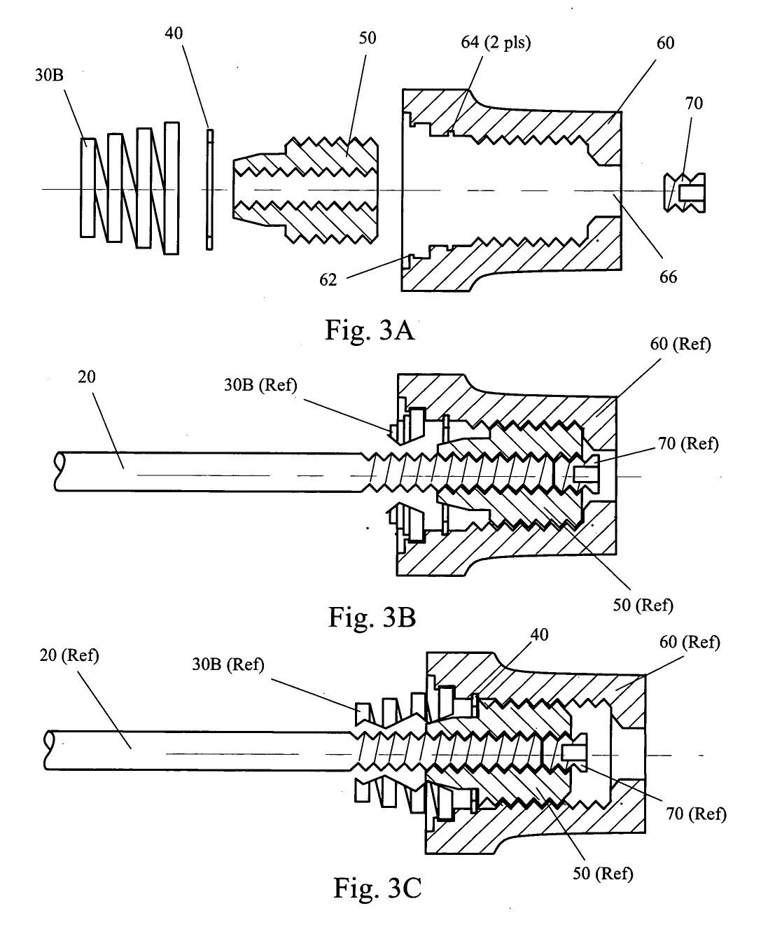

Turning now to FIG. 2, several views of the details of a first embodiment of the present invention are shown. Note that while FIG. 2, as well as FIGS. 3, 4, and 5, discuss the details of the present invention with respect to a driven, or rear wheel, the apparatus is suitable for both driven and non-driven wheels, thus may be used for both front and rear wheel applications.

Beginning with FIG. 2A, an exploded/sectioned view of the captive nut assembly 200 is shown including captive nut 60, insert 50, stop ring 40 and spring 30B. The outer threads of insert 50 mate with the internal threads of captive nut 60 such that the fit is not tight. As explained further below, this is so that when the rider turns the skewer rod 20, the insert 50 turns with respect to the captive nut 60 while remaining stationary to the insert 50. Stop ring 40 is of the c-ring type and snaps into slots 64 such that when the skewer rod/insert combination is turned, no lateral movement beyond stop ring 40 is permitted. Alternatively, stop ring 40 can be of the split ring type. Spring 30B snaps into place over shoulder 62 such that when lateral movement of the skewer rod 20 occurs, the spring 30B travels with captive nut assembly 200. In this way, when the wheel is removed from the chain stay lugs the spring remains with the captive nut assembly 200.

FIG. 2B shows the first embodiment of the present invention in the mounted condition. That is, when the wheel is mounted to the frame of the bicycle, insert 50 has traveled as far as possible along the internal threads of captive nut 60. Spring 30B has been compressed by the lug of the bicycle chain stay and has thus receded into the cavity of captive nut 60. While not shown for clarity, it will be understood by those skilled in the art that skewer rod 20 is connected to lever 15 and housing 10 of FIG. 1 in such a way as to cause the lateral movement of insert 50. Note that the threads of skewer rod 20 mate with the internal threads of insert 50 with an interference fit. This is done in order to assure that when skewer rod 20 is rotated by lever 15 of FIG. 1, the insert will move with respect to captive nut 60 while remaining stationary with respect to insert 50.

FIG. 2C shows the first embodiment of the present invention in the open, or dismounted condition. Here skewer rod 20 has been manipulated via lever 15 and housing 10 of FIG. 1 in such a way as to cause the insert 50 to move laterally toward stop ring 40. Once the stop ring 40 has been reached the movement of skewer rod 20 is inhibited and the rider knows that the proper separation gap has been attained and may now remove the wheel from the lugs of the bicycle frame. Spring 30B has expanded but remains with the captive nut 60 as described above.

Referring now to FIG. 3, several views of the details of a second embodiment of the present invention are shown. Beginning with FIG. 3A, an exploded/sectioned view of the captive nut 60, set screw 70, insert 50, stop ring 40 and spring 30B is shown. The outer threads of insert 50 mate with the internal threads of captive nut 60 such that the fit is not tight. As explained further below, this is so that when the rider turns the skewer rod 20, the insert 50 turns with respect to the captive nut 60 while remaining stationary to the insert 50. Stop ring 40 snaps into slots 64 such that when the skewer rod/insert combination is turned, no lateral movement beyond stop ring 40 is permitted.

Spring 30B snaps into place over lip 62 such that when lateral movement of the skewer rod 20 occurs, the spring 30B travels with captive nut 60. In this way, when the wheel is removed from the chain stay lugs the spring remains with the captive nut 60.

Hole 66 is provided in the end of captive nut 60 to allow access to set screw 70. The purpose of set screw 70 is to exert a captive force on the end of skewer rod 20. This is required since the fit between the threads of skewer rod 20 and the internal threads of insert 50 is no different than the fit between the external threads of insert 50 and the internal threads of captive nut 60. If no captive force were provided it would not be clear which element of the apparatus would move when the skewer rod 20 is rotated. With the application of the captive force the skewer rod/insert combination remains fixed allowing the insert 50 to move with respect to captive nut 60.

FIG. 3B shows the second embodiment of the present invention in the mounted condition. That is, when the wheel is mounted to the frame of the bicycle, insert 50 has traveled as far as possible along the internal threads of captive nut 60. Spring 30B has been compressed by the lug of the bicycle chain stay and has thus receded into the cavity of captive nut 60. While not shown for clarity, it will be understood by those skilled in the art that skewer rod 20 is connected to lever 15 and housing 10 of FIG. 1 in such a way as to cause the lateral movement of insert 50. Note that the threads of skewer rod 20 mate with the internal threads of insert 50 and are held in place by the captive force generated by set screw 70. This is done in order to assure that when skewer rod 20 is rotated by lever 15 of FIG. 1, the insert will move with respect to captive nut 60 while remaining stationary with respect to insert 50.

FIG. 3C shows the second embodiment of the present invention in the open, or dismounted condition. Here skewer rod 20 has been manipulated via lever 15 and housing 10 of FIG. 1 in such a way as to cause the insert 50 to move laterally toward stop ring 40. Once the stop ring 40 has been reached the movement of skewer rod 20 is inhibited and the rider knows that the proper separation gap has been attained and may now remove the wheel from the lugs of the bicycle frame. Spring 30B has expanded but remains with the captive nut 60 as described above.

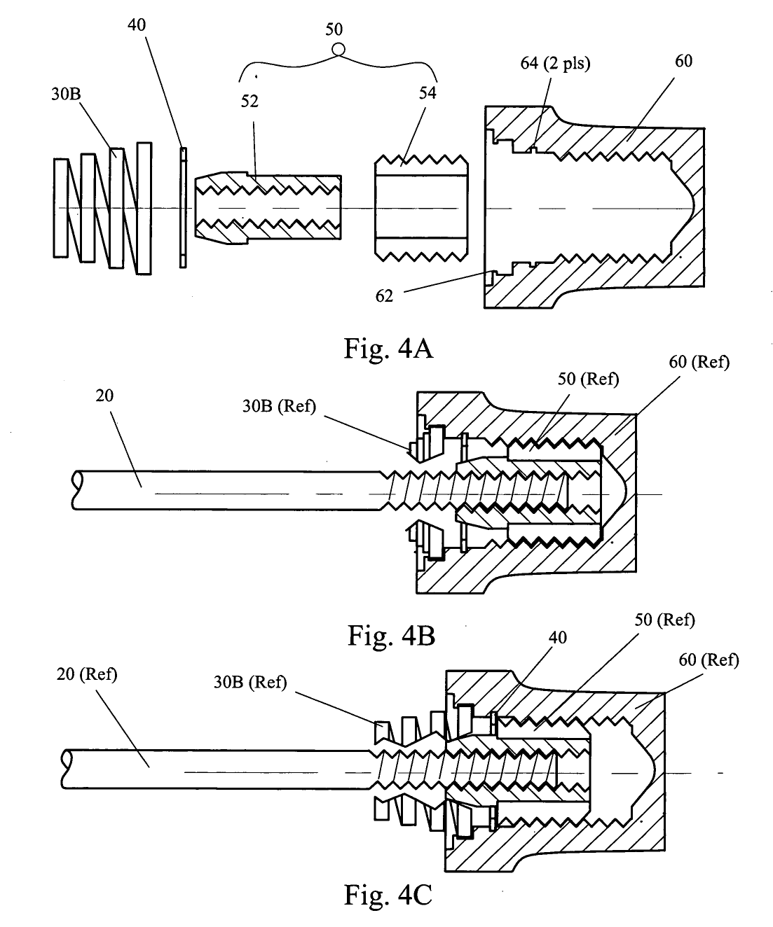

Looking now to FIG. 4, several views of the details of a third, preferred embodiment of the present invention are shown. Beginning with FIG. 4A, an exploded/sectioned view of the captive nut 60, insert 50, stop ring 40 and spring 30B is shown. In this third embodiment, the insert 50 is further comprised of outer sleeve 54 and inner barrel 52. Outer sleeve 54 is made of the same material as captive nut 60, typically aluminum. Inner barrel 52 is made of a material such as neoprene. Inner barrel 52 is force fit into outer sleeve 54, together forming insert 50.

The outer threads of insert 50 mate with the internal threads of captive nut 60 such that the fit is not tight. As explained further below, this is so that when the rider turns the skewer rod 20, the insert 50 turns with respect to the captive nut 60 while remaining stationary to the insert 50. Stop ring 40 snaps into slots 64 such that when the skewer rod/insert combination is turned, no lateral movement beyond stop ring 40 is permitted. Spring 30B snaps into place over lip 62 such that when lateral movement of the skewer rod 20 occurs, the spring 30B travels with captive nut 60. In this way, when the wheel is removed from the chain stay lugs the spring remains with the captive nut 60.

FIG. 4B shows the third, preferred embodiment of the present invention in the mounted condition. That is, when the wheel is mounted to the frame of the bicycle, insert 50 has traveled as far as possible along the internal threads of captive nut 60. Spring 30B has been compressed by the lug of the bicycle chain stay and has thus receded into the cavity of captive nut 60. While not shown for clarity, it will be understood by those skilled in the art that skewer rod 20 is connected to lever 15 and housing 10 of FIG. 1 in such a way as to cause the lateral movement of insert 50. Note that the threads of skewer rod 20 mate with the internal threads of insert 50 with an interference fit. Recall from above that the inner barrel 52 is a soft material such as neoprene while the threads of the skewer rod 20 are formed from a hard material, for example, steel. The combination of the inner barrel 52 and outer sleeve 54 form a jam nut. This is done in order to assure that when skewer rod 20 is rotated by lever 15 of FIG. 1, the insert will move with respect to captive nut 60 while remaining stationary with respect to insert 50.

FIG. 4C shows the third, preferred embodiment of the present invention in the open, or dismounted condition. Here skewer rod 20 has been manipulated via lever 15 and housing 10 of FIG. 1 in such a way as to cause the insert 50 to move laterally toward stop ring 40. Once the stop ring 40 has been reached the movement of skewer rod 20 is inhibited and the rider knows that the proper separation gap has been attained and may now remove the wheel from the lugs of the bicycle frame. Spring 30B has expanded but remains with the captive nut 60 as described above.

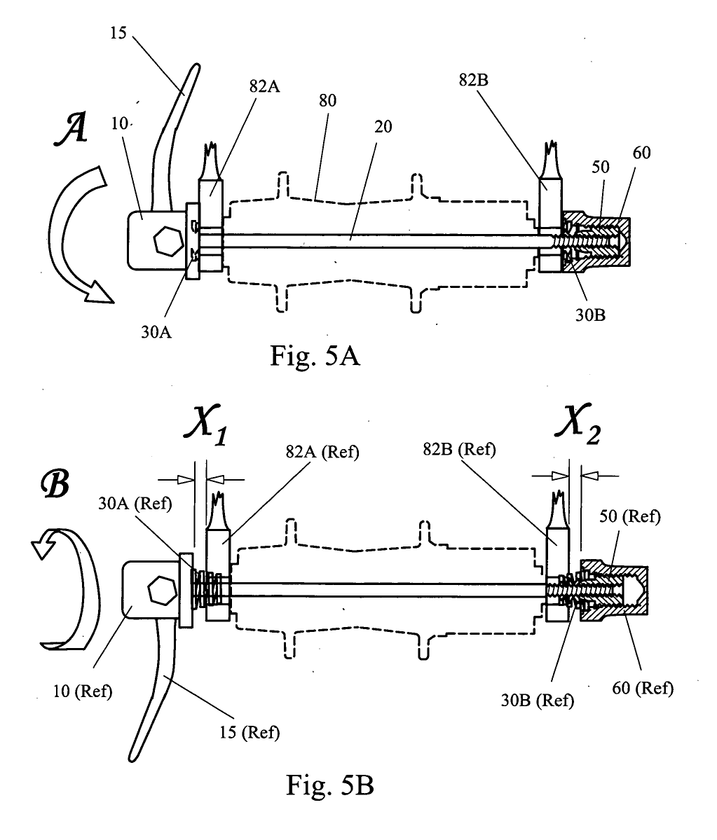

Operation of the apparatus of the present invention is shown in FIG. 5. Beginning with FIG. 5A, the apparatus is shown in the closed, or wheel mounted condition. Note that while not part of the invention, the chain stay lugs 82A and 82B as well as a typical hub assembly 80 are shown for reference. Initial adjustment of the apparatus of the present invention is accomplished in one of two ways. For the first and third embodiments, the wheel is placed in the lugs 82A and 82B of the bicycle frame with lever 15 in the up, or closed position. Recall that lever 15 operates a cam internal to housing 10 in a way that moves skewer rod 20 laterally.

Captive nut 60 is rotated until it is snug against the driven side frame lug 82B. Doing this accomplishes two actions: first, insert 50 travels until it abuts the inside of captive nut 60, and second, continuing to turn captive nut 60 causes insert 50 to reach its final position on rod 20. Since the skewer rod/insert combination in both the first and third embodiments depends on a shear force differential, when the skewer rod 20 is turned, only the insert will move with respect to the captive nut.

At this point the lever 15 is moved to the open position as indicated by arrow A. The rider then turns the captive nut approximately one quarter of a turn further. This quarter turn provides the correct clamping force against the lugs. Moving the lever 15 to closed position now applies the clamping force. At this time the skewer of the present invention is properly set and no further adjustment will be needed.

For the second embodiment of the present invention initial adjustment is accomplished in slightly different manner. This is because the set screw (70 of FIG. 3A) is used to provide the captive force needed to maintain the proper fixed relationship between the skewer rod 20 and the insert 50. As with the first and third embodiments, captive nut 60 is rotated until it is snug against the driven side frame lug 82B. Doing this accomplishes two actions: first, insert 50 travels until it abuts the inside of captive nut 60, and second, continuing to turn captive nut 60 causes insert 50 to reach its final position on skewer rod 20.

At this point the lever 15 is moved to the open position as indicated by arrow A. The rider then turns the captive nut approximately one quarter of a turn further. This quarter turn provides the correct clamping force against the lugs. The set screw 70 of FIG. 3A, accessed through hole 66 of FIG. 3A, is tightened against the end of skewer rod 20 to apply the captive force needed to ensure that the relative position of skewer rod 20 and insert 50 remains constant. Moving the lever 15 to closed position now applies the clamping force. At this time the skewer of the present invention is properly set and no further adjustment will be needed.

Turning now to FIG. 5B, to remove the wheel from the bicycle the rider moves the lever 15 to the open position, approximately 180 degrees as indicated by arrow B. This action removes the clamping force and allows the rider to turn lever 15 counterclockwise until insert 50 hits stop ring 40 of FIG. 2C. When the insert 50 has reached stop ring 40 of FIG. 2C the gaps X₁ and X₂ are formed. These gaps are approximately even due to the action of springs 30A and 30B, each being approximately 0.1 inch. Gap X₁ between housing 10 and chain stay lug 82A in combination with gap X₂ between captive nut 60 and chain stay lug 82B provide the approximately 0.2 inch required to clear the safety tabs on the end of the majority of modern bicycles.

With lever 15 in the open position the rider is able to remove the wheel from the bicycle frame. Once the rider has accomplished the maintenance of the wheel, for example, changing a flat tire, the wheel may be replaced. Since the relative position of the insert 50 and captive nut 60 has not changed, the gaps X₁ and X₂ remain adequate for mounting the wheel without any adjustment to the skewer. Once the wheel is in place on the chain stay lugs 82A and 82B the lever 15 is turned clockwise until the insert 50 stops against the captive nut 60. Again, since the relative position of the insert 50 and captive nut 60 has not changed, the rider simply moves the lever 15 into the closed position which applies the proper clamping force without the need for any trial-and-error adjustment of the skewer. In this way the present invention significantly improves the efficiency of the skewer.

One advantage of the present invention is a significant improvement in the operation of the skewer. Once properly adjusted, the rider need only operate the skewer lever to remove or remount a bicycle wheel.

A second advantage of the present invention is the elimination of the need for a trial-and-error method to obtain proper clamping force on the chain stay lugs. Since the relative position of the various components of the present invention remain constant, no further adjustment is required.

A third advantage of the present invention is that it may be used for both front and rear wheels. The clearance provided by the operation of the apparatus provides the required gaps to allow either type of wheel to clear the safety tabs that are present on most modern bicycles.

What is claimed is:

1. An improved bicycle wheel axel skewer, the improvement comprising:
a cam housing on a first end of a skewer rod said cam housing containing a cam connected to a lever;
a first spring located on said first end of said skewer rod said first spring fixed within said cam housing by shouldered capturing means;
a second spring fixed in place by a shoulder located on the inside diameter of a captive nut assembly, and;
a captive nut assembly threadably attached to a second end of said skewer rod such that when said lever on said first end of said skewer rod is operated said cam contained within said cam housing causes said skewer rod and said captive nut assembly to move laterally a fixed distance.

2. A first embodiment of the captive nut assembly of claim 1 comprised of:
a captive nut having an internal threaded cavity, said threaded cavity having an open end and a closed end;
an insert having an external thread suitable for mating with said internal threaded cavity of said captive nut and an internal thread suitable for mating with the external thread of a skewer rod;
a c-ring, said c-ring fixed in place by a slot at said open end of said threaded cavity of said captive nut, and;
a spring fixed in place on the inside diameter of said captive nut by a shoulder such that said internal thread of said insert mates with said external thread of said skewer rod with sufficient interference force to allow said external thread of said insert to move freely between said c-ring at said open end of said threaded cavity and said closed end of said threaded cavity with respect to said internal thread of said captive nut upon rotation of said skewer rod.

3. A second embodiment of the captive nut assembly of claim 1 comprised of:
a captive nut having an internal threaded cavity, said threaded cavity having an open end and a closed end;
an insert having an external thread suitable for mating with said internal threaded cavity of said captive nut and an internal thread suitable for mating with the external thread of a skewer rod;
a set screw, said set screw having an external thread suitable for mating with said internal thread of said insert;
a c-ring, said c-ring fixed in place by a slot at said open end of said threaded cavity of said captive nut, and;
a spring fixed in place on the inside diameter of said captive nut by a shoulder such that said internal thread of said insert mates with said external thread of said skewer rod with sufficient interference force to allow said external thread of said insert to move freely between said c-ring at said open end of said threaded cavity and said closed end of said threaded cavity with respect to said internal thread of said captive nut upon rotation of said skewer rod, said skewer rod further fixed in place by said set screw.

4. A third embodiment of the captive nut assembly of claim 1 comprised of:
a captive nut having an internal threaded cavity, said threaded cavity having an open end and a closed end;
an insert having an external thread suitable for mating with said internal threaded cavity of said captive nut, said insert further comprised of;
an outer sleeve, said outer sleeve sleeve having an external thread suitable for mating with said internal threaded cavity of said captive nut and a non-threaded internal surface, and;
a inner barrel, said inner barrel having a non-threaded external surface suitable for force fit with said internal surface of said outer sleeve and an internal thread suitable for mating with the external thread of a skewer rod;
a c-ring, said c-ring fixed in place by a slot at said open end of said threaded cavity of said captive nut, and;
a spring fixed in place on the inside diameter of said captive nut by a shoulder such that said internal thread of said insert mates with said external thread of said skewer rod with sufficient interference force to allow said external thread of said insert to move freely between said c-ring at said open end of said threaded cavity and said closed end of said threaded cavity with respect to said internal thread of said captive nut upon rotation of said skewer rod, said skewer rod further fixed in place by said force fit between said inner barrel and said outer sleeve.

5. The captive nut assembly of claim 1 wherein the fixed distance lateral movement is approximately 0.2 inches.

6. The captive nut assembly of claim 2 wherein the captive nut and the insert are both made from aluminum.

7. The captive nut assembly of claim 2 wherein the captive nut and the insert are both made from titanium.

8. The captive nut assembly of claim 3 wherein the captive nut and the insert are both made from aluminum and the set screw is made of steel.

9. The captive nut assembly of claim 3 wherein the captive nut and the insert are both made from titanium and the set screw is made of steel.

10. The captive nut assembly of claim 4 wherein the captive nut, the outer sleeve and the inner barrel are all made from aluminum.

11. The captive nut assembly of claim 4 wherein the captive nut, the outer sleeve and the inner barrel are all made from aluminum.

12. A method for removing a bicycle wheel from the frame of a bicycle using an improved bicycle wheel axel skewer comprising:
operating a cam connected to a skewer rod by a lever wherein said lever is operated through an arc of approximately 180 degrees;
rotating said lever counter-clockwise until an insert contained within a captive nut assembly reaches a c-ring, said c-ring preventing any further rotation of said lever;
removing the wheel from the frame lugs of a bicycle frame;
performing required actions upon said bicycle wheel;
replacing said bicycle wheel in said frame lugs of said bicycle frame;
rotating said lever clockwise until said lever is prevented from further rotation, and;
operating said lever approximately 180 degrees clockwise.
